(19) United States
(12) Patent Application Publication
(10) Pub. No.: US 2002/0188568 A1
(43) Pub. Date: Dec. 12, 2002

(54) Systems and methods of containing and accessing generic policy

(75) Inventors: Niel Raymond Nickolaisen, Centerville, UT (US); Glen Brewer Lewis, Sandy, UT (US); Michael Sean Whyte, Castle Rock, CO (US)

Correspondence Address: Parsons, Behle & Latimer, Suite 1800, 201 South Main Street, P.O. Box 45898, Salt Lake City, UT, 84145-0898, US

(73) Assignee: Center 7, Inc.

(21) Appl. No.: 10/042,129

(22) Filed: Jan. 8, 2002

Related U.S. Application Data
(60) Provisional application No. 60/260,347, filed on Jan. 8, 2001.

(51) Int. Cl. G06F 17/60

(52) U.S. Cl. 705/52

(57) ABSTRACT

A policy repository having facilities to enter, store, search for, and retrieve generic policy easily adaptable for application to enterprise devices. That respository having means of restricting access by way of authentication. Methods of using and applying generic policy using a policy repository.

### CROSS-REFERENCE TO RELATED APPLICATIONS

This application claims the benefit of U.S. Provisional Application No. 60/260,347 filed Jan. 8, 2001.

### BACKGROUND OF THE INVENTION

The present invention relates generally to management of enterprise systems and more particularly to management of multiple enterprise systems from a central location through the use of an intermediate computer system which facilitates reporting conditions in and maintaining an enterprise.

The rise of the Internet has brought new forms of business. These businesses use networked computers and the Internet to supplement, and in some cases supplant, older forms of communication, accounting, news delivery, and many other kinds of activities. Such a group of interconnected computer and electronic resources serving a business purpose are referred to as an enterprise.

Today there are many businesses exposed to interruption of business activity and significant financial losses in the event networks and computer systems fail. For many years enterprises remained small, thus skilled persons could be hired to monitor the operation of these systems to lessen the likelihood and effects of such failure. Today's enterprise systems sometimes contain a hundred or more individual components, often spread in different locations across a country or the world. It becomes cost-prohibitive to train and hire the staff needed to monitor such an operation. This situation has led to a realization that software is needed to assist these operators in monitoring and maintaining their enterprises.

Software which assists operators to monitor and maintain enterprises is referred to as enterprise management software. In its essence, this software collects status reports from the devices comprising the enterprise, interprets information therein, and organizes the information into a readable form. The software presents this information to an operator in some fashion, often by way of a web browser. There may also be software components, called agents, installed to the enterprise devices and network which monitor portions of the enterprise and send status reports to be collected. Other functions are sometimes performed by enterprise management software, including scanning networks for compatible devices and agents, job scheduling, backups, and system performance analysis and prediction.

Common transports for such status reports are Simple Network Management Protocol (SNMP) and Common Management Information Protocol (CMIP). These standard transports provide methods of communicating the state of network-enabled devices to other interconnected computers. SNMP may be implemented over the Internet Protocol (IP), which is supported by most current networks. SNMP version 1 is by far the most commonly used network management protocol at the time of this writing, with many vendors of network products providing SNMP functionality as an important product feature.

Speaking in general terms, the SNMP protocol communicates the status of network devices in messages called protocol data units, or PDUs. In normal operation, when it is time to query the status of a device the network management software will submit a “get” request to the network device encapsulated in a PDU. The network device responds with a single value representing the device status encapsulated in a separate PDU. If successive responses are required to collect further information, the network management software will submit a “get next” request, which is responded to by the device sending successive values each encapsulated in separate PDUs. A “set” PDU may be sent to a device to set a variable to a value. And lastly a “trap” PDU may be sent to a listening entity from a device indicating a transition in the state of the device.

SNMP uses a configuration database known as a management information base, or MIB. In essence, the MIB contains information of each managed device including such things as a list of capabilities and variables and the address by which the device may be reached. The address of each device is composed of a unique object identifier, or OID. A managing program, such as the enterprise management software, may reference the MIB to gather what devices are accessible, what information may be requested, how to request that information, and where a device may be addressed on the network.

Current enterprise management software not only permits communication of the state of devices in an enterprise to a user, but also may execute actions under some conditions. Instructions to execute upon recognition of a particular state are known as policy. For example, it might be helpful to notify a network administrator if a web server becomes inoperative. Policy for such a situation would include the condition of the web server being unreachable, and the instructions to email a problem report and page the network administrator. Other examples where policy might also be useful would be to notify an administrator if a hard disk on a server is nearly full, or to restart a network router if the network becomes unreachable.

There are a number of such enterprise management software packages currently available. These include Unicenter TNG by Computer Associates of Islandia, N.Y., OpenView by Hewlett Packard of Palo Alto, Calif., Tivoli by Tivoli Systems Inc. of Austin, Tex., and others. These products have matured and continue to develop.

There are a number of limitations with existing enterprise management systems. First, they require an uncommon expertise. Current educational and training standards do not encompass the use of available enterprise management software, and such skills are not recognized as notable for those in the computer field. Thus a business wishing to establish an enterprise must expend time and money to train staff to set up these management systems. Additionally, this staff must be retained in the employ of the business to maintain the enterprise, incurring further expense.

Second, sometimes it is desired to monitor a critical software application that does have support for standard network management. Such an application might be a new product for which network management functions have yet to be written, or a legacy product no longer in development. In such cases a sort of “glue” application must be written which monitors the application and reports status to the network management. Businesses have no incentive to share these specialized applications with other businesses, so each business must expend more time and money to develop these glue applications.

Third, further duplication of effort occurs when businesses implement policy. Many enterprises utilize similar components, such as web servers and databases. The policy for such similar components will be largely the same across different enterprises. For example, an administrator will normally need to be notified using the swiftest means in the event the main web server crashes. Thus the policy for most web servers will reflect that the administrator be paged upon detection of catastrophic malfunction of the main web server. Administrative staff across organizations are likely to implement similar policy for many types of network devices, but as there is no reliable method of sharing policy further redundant effort will be expended in generating and perfecting policy.

Fourth, these businesses do not benefit from testing of these glue applications and policy beyond the use of their own enterprises. It is well recognized that a large pool of testers is more likely to discover the bugs in a system than a small pool. Applications and policy in wide use would be more fully tested and reliable.

Fifth, some enterprise software packages contain applications which predict future enterprise state, and report such predictions to the enterprise maintainers. As such software encompasses a single enterprise, the predictions are limited to input data of only one enterprise, which may be an inadequate predictor. One enterprise may have experienced failures similar to what may occur in a second enterprise, but predictions cannot be asserted for the second enterprise using data from the first with the present state of the art systems.

Thus it follows from this and other reasons there is a need for a way to configure and operate enterprise management systems by a single expert administrative entity to reduce the administrative and financial burdens on the owners of such systems thereof.

### BRIEF SUMMARY OF THE INVENTION

Among other objects, it is an object of the invention to provide a policy repository to facilitate the storing, entry and retrieval of generic policy.

Additional objects, advantages, and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described the preferred embodiments of this invention, simply by way of illustration of one of the modes best suited to carry out this invention. As it will be realized, this invention is capable of other different embodiments, and in its several details it is capable of modification without departing from the concept of the invention. Accordingly, the drawings and descriptions should be regarded as illustrative in nature and not as restrictive.

### BRIEF DESCRIPTION OF THE SEVERAL VIEWS OF THE DRAWINGS

The accompanying drawings incorporated in and forming a part of the specification, illustrate a preferred embodiment of the present invention. Some, although not all, alternative embodiments are described in the following description. In the drawings:

FIG. 1 illustrates the high-level interconnectivity of a system of the invention.

FIG. 2 illustrates a high-level logical representation of a system of the invention.

FIG. 3 illustrates by example a method of using a policy repository.

FIG. 4 illustrates by example a policy repository system of the invention.

### DETAILED DESCRIPTION OF THE INVENTION

Policy is the principal management tool of enterprise management systems. Policy contains the rules for monitoring and event responses. A typical enterprise management system policy will contain three elements. The first element is a set of system conditions to be evaluated. Examples of this are the CPU utilization of a database server and data input rate of a data switch. The second element is a set of system conditions that will trigger a enterprise management system response. One example is CPU utilization of a database server exceeding 80% for more than 10 seconds or more than 5 times in 30 seconds. The third element is a set of enterprise management system responses, or actions, for each triggering condition. In the given example for a database server an appropriate response might be sending a notification page to a systems administrator and initiating backup of the database data.

In deploying an enterprise management system, a significant amount of time is required to define and develop policy for the myriad conditions that can occur in technology systems. However, some elements of enterprise management system policy for specific devices can be typified for multiple devices and users. By creating and supporting a repository for enterprise management system policy it is possible to eliminate the most time and resource consuming work of enterprise management system deployment and ongoing use.

For example, in the case of the database server outlined above, some general CPU utilization thresholds would be chosen, perhaps the 80% utilization point being a good typical value. The action of backup of data would also likely be a good action generally. An entry might also exist specifying notification, although that entry might be inactive pending revision by the administrator. The administrator could then retrieve the policy, provide contact information to the notification entry, optionally modify the CPU utilization thresholds, and apply the revised policy. Policy being containing generic conditions, thresholds, and actions and being capable of easy modification for a specific application is referred to as generic policy.

A policy repository of the invention contains a database of generic enterprise management system policy. The policy repository has facilities for users to access the database to retrieve policy intended to be modified by a user for particular enterprise device applications. The policy repository may additionally have facilities for searching the database, thereby allowing a user to search for policy for particular applications. The policy repository may also have facilities for entry of new policies into the database and indexing those new entries for the searching facilities, if provided. The policy repository may further have facilities for authentication, whereby access to the database is restricted to only those authorized for such access.

For example, the policy database might have a pre-written policy for a Cisco 7500 series router. This policy might be indexed at the top level by device type, a Cisco 7500 series router, then by the type of use, such as WAN or LAN usage, and finally by use case such as high, medium, or low traffic use cases.

Policy entered to the database is normally written for a typical application of a device. An example of an ordinary policy entry in the database will contain typical usage and performance metrics, typical event thresholds, and typical system responses. Users of this policy adjust these thresholds and responses as needed for their specific needs. For example, the pre-written policy for a database server might include a warning threshold for CPU utilization. A user of this policy would retrieve the policy for the database server from the database, and revise the pre-written policy by adjusting the threshold setting and by adding contact information specific to the system administrator.

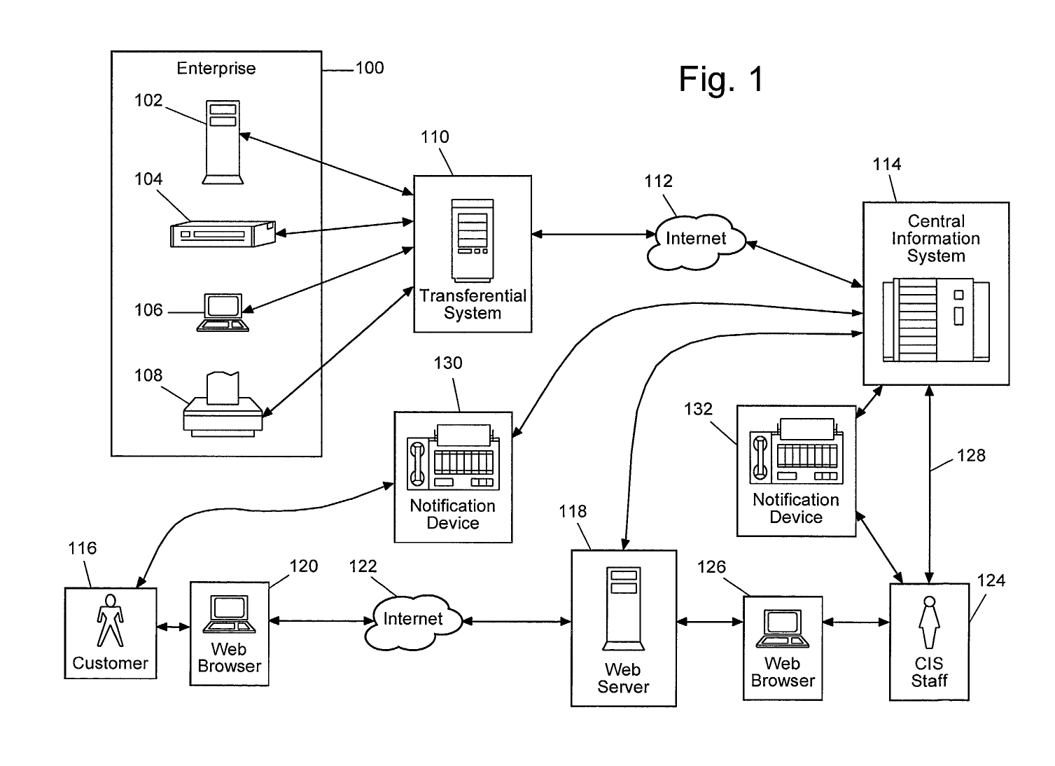

FIG. 1 illustrates by example the high-level interconnection of a system of the invention. Enterprise 100 includes a set or subset of networked computer and electronic devices serving a business purpose which are deemed necessary to be monitored and maintained. Such networking would normally be encompassed by a local area network (or LAN), although super-LAN implementations are possible if sufficient bandwidth is provided. Examples of networked computer and electronic devices are shown as a server 102, a disk array 104, a workstation 106, and a network enabled printer 108. For the purposes of this writing, a network enabled object is an object that may be configured to be controlled or communicate status over a network. Such computer and electronic devices may include any other device which can be networked into enterprise 100.

Transferential system 110 is a computer system connected to devices shown by example as 102, 104, 106, and 108 with software to communicate status and status requests between the devices and the central information system 114 through a network connection 112, which is shown by way of example as the Internet. Examples of other connections which can be used are virtual private network connections and private network lines. Transferential system 110 is located in communicative proximity to the devices so as to permit sufficient bandwidth for communication to the devices at a low cost. One embodiment of the invention communicates status messages initiated by a device when specific events are encountered. The messages are sent to transferential system 110 which are forwarded to central information system 114. Examples of specific events are a timer expiring, and an error condition encountered. Another embodiment of the invention communicates device status by central information system 114 sending a status request message destined for a designated device through transferential system 110, which message is responded to by the designated device, if the state of the designated device allows, back to central information system 114 through transferential system 110. Transferential system 110 may also contain software to execute policy instructions on receipt of status messages from the devices. One or more transferential systems 102 may be used per LAN, as may be required if enterprise 100 spans multiple LANs or to improve the message throughput between the devices and the central information system 114.

Central information system 114 is one or more computers having enterprise management software installed thereon to receive and maintain state information of devices shown by example as 102, 104, 106, and 108 in enterprise 100. Central information system 114 facilitates monitoring and maintaining multiple enterprises 100. Central information system 114 may further contain software to execute policy instructions stored in memory contained within central information system 114. Central information system staff 124 manage the operation of central information system 114. Communication utility 128, such as a terminal, may be provided between central information system 114 and central information system staff 124 for monitoring and maintaining central information system 114. Central information system 114 is separable, with respect to physical locality, from enterprise 100 and transferential system 110 provided that network connection 112 provides sufficient bandwidth for communication to and from transferential system 110. In a typical embodiment, central information system 114 is operated by a managing party including central information system staff 124 different than those parties operating multiple enterprises 100. In that embodiment, the managing party may monitor and manage enterprises 100 through central information system 114.

A presentation server system 118, shown by way of example as a single web server, is provided to allow state information received by central information system 114 to be presented in a humanly readable format. A customer 116 may view the state of his enterprise 100 by accessing presentation server system 118 through local application software 120, shown by example as a web browser, through a network 122, which is shown by example as the Internet. Central information system staff 124 may also access enterprise state information through presentation server system 118 through local application software 126, also shown by example as a web browser. Presentation server system 118 may also provide a user interface for configuring central information system 114 and other functions as desired. Presentation server system 118 may comprise multiple servers as desired which may, among other purposes, serve the purpose of reducing network congestion or improving response time.

Central information system 114 may contain policy instructions which notify a customer 116 or central information system staff 124 of enterprise status by way of a notification message. Notification device 130 and notification device 132 are provided to notify customer 116 and central information system staff 124, respectively, of such status. Examples of notification devices are a telephone message system, a paging system, and an email system. Two notification devices 130 and 132 are shown by way of example; one or more notification devices are necessary to provide notification messages to customers 116 and central information system staff 124. Notification devices 130 and 132 may incorporate methods for customer 116 and central information system staff 124 to submit a response or acknowledgment message to a notification message to central information system 114. Notification devices 130 and 132 may report the results of a notification attempt to central information system 114 which may cause further execution of policy. Presentation server 118 and communication utility 128 may also provide a mechanism by which response or acknowledgment messages may be returned to central information system 114.

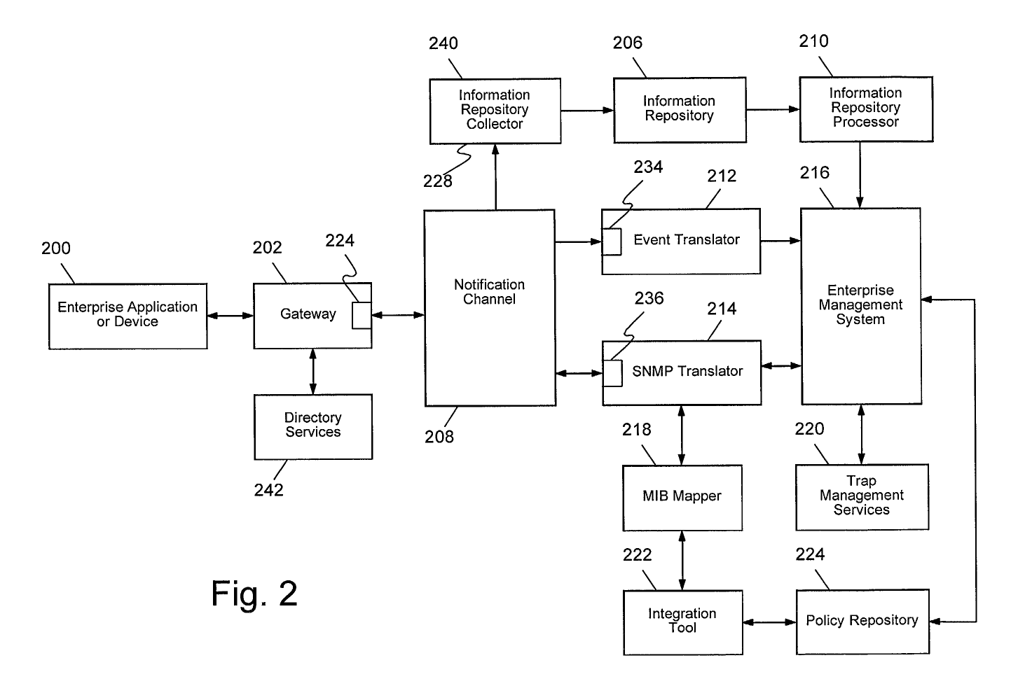

FIG. 2 illustrates a high-level logical representation of a system of the invention. A network enabled device 200, or a software application executing on that device, is to be monitored as a component of an enterprise. Examples of such devices are servers, workstations, network appliances and network printers as mentioned in connection with enterprise 100 from FIG. 1. Device 200 reports status information messages to a gateway 202 using a particular protocol, two examples of protocols being HTTP and TCP socket based protocols. Such messages may be initiated by an event, such as a timer expiring or an error condition, or by a status request message from gateway 202.

Gateway 202 is a software system which serves as an interface between enterprise device 200 and notification channel 208. Gateway 202 translates messages in the particular protocol used by device 200 to the notification channel protocol used by notification channel 208, and vice versa. In one embodiment gateway 202 retrieves operational configuration from directory services 242, described below. Gateway 202 subscribes to notification channel 208 using a filter that selects only devices 200 which are logically connected, such subscription being described below. Gateway 202 receives messages destined for device 200, such messages containing a unique identifier for the device 200. When such a message is placed in notification channel 208, gateway 202 extracts the message, translates the message to the particular protocol used by device 200, and transmits the translated message to device 200. Gateway 202 also listens to device 200, receiving and translating messages therefrom and placing translated messages into notification channel 208 using the notification channel protocol, described below.

A message in the notification protocol must contain at least two information fields. One required field is an identifier for the sender. The other required field is a substantive message that is meaningful to the destination. In a preferred embodiment a service identifier and security token is provided, whereby the message may be authenticated against a number of service types. In that preferred embodiment a severity declaration is also provided, whereby messages of higher importance may be specially treated. Optional fields may contain the time the message was generated or created, the time the message was received at the destination, the subsystem that originated the message, the object oriented method that originated the message, and a plain text error message. Optionally an SNMP OID may be contained in the message to facilitate delivery to the destination. In a preferred embodiment an original SNMP message is wrapped into a notification protocol message by including the SNMP message in the substantive message field.

Notification channel 208 provides message routing and transport facilities for messages coming to and from managed devices 200 through gateways 202. Communicative objects, such as gateways 202 or SNMP translator 214, may place messages into the notification channel 208, where they are forwarded to one or more other communicative objects, such as gateways 202, information repository 206, and event translator 212. In order to receive messages from notification channel 208, a communicative object must subscribe to the notification channel 208 with a filter criteria. After such subscription a communicative object will then be notified when a new message is available for retrieval from notification channel 208 within the bounds of the filter criteria. In a preferred embodiment of the invention notification channel 208 provides a short term storage for retaining passing messages. In that embodiment a mechanism of discarding old messages to make room for new messages in memory storage should also be provided. Notification channel 208 also implements facilities to retrieve subsets of the contained messages based on filter criteria. The system of the invention may have one or more notification channels 208 as desired for organizational purposes. Notification channel 208 may also implement an authentication scheme whereby communicative objects must be authenticated before placing or retrieving messages from notification channel 208.

Communication to and from notification channel 208 is provided in a preferred embodiment by regular connectors 224, 228, 234 and 236. CORBA (Common Object Request Broker Architecture) is a software specification that provides a framework for sharing objects in a distributed computing environment, which provisions may be utilized in regular connectors to provide a simple method of passing messages and other information to different networked computers within the system of the invention. In a preferred embodiment regular connectors are implemented using the CORBA specification, which are then referred to as CORBA connectors. One embodiment of a regular connector consists of two unidirectional channels through which messages may pass. Each channel consists of software for receiving messages, software for transmitting messages, and a queue where messages may be stored after receipt but before transmission. Two channels operating in opposite directions provide bi-directional communication. Another embodiment of a regular connector consists of four unidirectional channels. Two pairs of unidirectional channels operating in opposite directions form two bi-directional channels, one pair for low priority and the other pair for high priority messages. Regular connectors may be useful for communication in other parts of the invention and may be included where desired. Persons skilled in the art will recognize that communication as provided by these regular connectors may be implemented in many possible ways; thus inclusion of regular connectors is not required to practice all systems of the invention.

Enterprise management system 216 is one or more computers with enterprise software installed thereon performing at least the tasks of communication with devices 200 in a device management protocol, such as SNMP, and providing an interface by which persons may be presented the state of an enterprise. In an alternative embodiment, enterprise management system 216 also contains facilities to execute policy. Enterprise management system 216 in a preferred embodiment is referred to as the Master Stack.

Event translator 212 is a software system that subscribes to and receives messages from notification channel 208 using a filter to receive those messages that need to be communicated to the enterprise management server 216 soon after those messages are placed in the notification channel. Such messages are normally initiated by devices 200, without a status request message being sent to them. Such messages may be initiated by an event, such as a timer expiring or an error condition. When the presence of such a message is detected by event translator 212 in notification channel 208 the message is received therefrom, translated to one or more messages in the protocol used by enterprise management system 216, and those translated messages communicated to the enterprise management system 216 which may trigger the execution of policy. For example, a server device 200 may have run out of disk space. Server device 200 would then send a message to gateway 202, the message being marked with a flag indicating urgency. Gateway 202 would then translate the message into the notification protocol and place the translated message into notification channel 208. Event translator 212, in this example having subscribed to notification channel 208 with a filter to detect only messages with the urgent flag set, detects and receives the message from notification channel 208. Event translator 212 then translates the message into SNMP and transmits the translated message to enterprise management system 216. Enterprise management system may then execute policy to notify the central information system staff and the customer of the problem.

SNMP translator 214 is a software system that receives request messages for a particular device 200 from enterprise management system 216 using the enterprise management system protocols, SNMP being one possible protocol. Such request messages may include, but are not restricted to, requests to configure device settings and requests for status information. The request message is converted into one or more messages in the notification channel protocol, intending to cause a response from the particular device 200 with the information required by the request message. Such conversion is facilitated by information from MIB mapper 218. The converted messages are placed into notification channel 208, and received by a gateway 202 subscribed to receive messages for the particular device. Gateway 202 translates each message into the protocol used by the particular device 200 and transmits them thereto. If in condition to respond, the particular device 200 then submits a response for each message to SNMP translator 214 through gateway 202 and notification channel 208. SNMP translator 214 then builds and submits a response to the original request message to enterprise management system 216 in the protocol used thereto.

For example, a customer may call up a display of a portion of his enterprise system. Enterprise management system 216, which uses the SNMP protocol, will send status requests for each device 200 to be displayed. SNMP translator will receive each status request message, translate each message from SNMP to messages in the notification channel protocol, place those messages in the notification channel, wait for and receive the responses from the notification channel, translate the responses back to SNMP and transmit those response messages to the enterprise management system 216.

SNMP translator 214 may also contain state information associated to devices 200, such that requests to configure or read the state of a device 200 may be responded to in an expected fashion to enterprise management system 216, expecially if those requests are not meaningful for device 200.

MIB mapper 218 is a software tool that provides conversion information to convert messages in the enterprise management system protocol to messages in the notification channel protocol and vice versa. MIB mapper 218 contains a database of such conversion information, and may also contain facilities for entry and editing of such conversion information. Conversion information specifies the functions of conversion of the device identifier, or device address, and the conversion of particular kinds of request and response messages.

Trap management services 220 is a software system, shown connected to and serving enterprise system 216 by example, supplying a contraindicating message after receipt of a trap message when the trap message is no longer indicative of the state of a device 200. A trap message, for the purposes of this writing, is a message that without external intervention will cause the enterprise management software to have a potentially perpetual incorrect representation of an enterprise device 200. For example, a device 200 has two states, normal state A and abnormal state B. On encountering an error condition the device goes from state A to state B and sends a status report to the enterprise management software noting this transition. Through administrative intervention or otherwise the device returns to state A, but without sending a new status report. There is no possible way for the representation of the device in the enterprise management system to return to normal state A automatically, and the enterprise management software will represent the device in abnormal state B perpetually until intervention is performed.

Trap management services 220 serves the purpose of noting and reporting transitions of state of devices 200, for devices 200 do not report these transitions themselves in self-initiated status messages. Trap management services 220 may poll the status of such devices 200, and send status messages in proxy of devices 200 to enterprise management system 216 to correct the device representation therein. Trap management services 220 may also be connected to and serve other system components which contain state representing the state of devices 200 such as notification channel 208.

Policy repository 224 is a database and software tool containing policies, possibly in various conditions. Generic policies may be included for typical configurations of devices 200. Generic policies may be extracted from policy repository 224, modified as required, and placed into service in the enterprise management system 216. Policy repository 224 may contain such extraction, modification, and placement facilities. Policy repository 224 may also contain divisions for policies which are trusted and distrusted, tested and untested, or other divisions as deemed necessary. Policy repository contains facilities to insert and extract policy into the contained database, and may also contain facilities to edit policies and to move policies from one division to another. Policy repository 224 may contain facilities for searching the policy database contained within and for modification of policies to suit a particular configuration of a device 200. Policy repository 224 may facilitate to recycle policies from within an enterprise, or across enterprises.

Integration tool 222 is a software system which assists a person to add an entry for a new device 200 to MIB mapper 218 and optionally create new policy for insertion to enterprise management system 216 for that new device 200. Integration tool 222 may contain facilities to search entries in a database containing information compatible with MIB mapper 218, and to insert new entries to MIB mapper 218. Integration tool 222 may also contain facilities to search the policy database in policy repository 224, or other policy database, and may also contain facilities for modification of policies and insertion of policies into policy repository 224 or enterprise management system 216.

Information repository 206 is a software system having the function of receiving messages from notification channel 208, having subscribed thereto with a broad filter capturing messages across multiple devices in one or more enterprises. Information repository 206 retains a historical message database composed of such messages over a longer period of time than the message persistence provided by notification channel 208, such period of time normally being longer than one week. The historical message database contained may be searched by external applications and provides an interface for searching and delivery of subsets of the historical messages based on filter criteria. Information repository collector 240 is a system that saves messages passing through notification channel 208 to information repository 206.

Information repository processor 210 is a software system having the function of retrieving historical messages from information repository 206, and performing analysis on those historical messages. Human readable reports may, but are not required to be, formed from such analysis. Information repository 206 is supplied with historical messages by information repository collector 240. Date warehouse collector 240 may optionally contain facilities to filter messages from notification channel 208 such that messages not required by information repository processor 210 are not saved to information repository 206. Information repository processor may predict the future state of devices 200 based on data contained within historical messages. Information repository processor 210 may deliver such prediction information to enterprise management system 216. Such information may be used to alert an administrator of an impending situation.

In one embodiment, directory services 242 provides facilities of access control to various components of the system of the invention. Directory services 242 may provide centralized authentication services for other components of the system such as gateway 202, thus restricting the entry or extraction of messages from notification channel 208. Directory services 242 may also provide configuration for gateways 202. Such configuration may optionally include a list of enterprise devices and applications 200, the number of communicative worker threads, and other configuration as desirable.

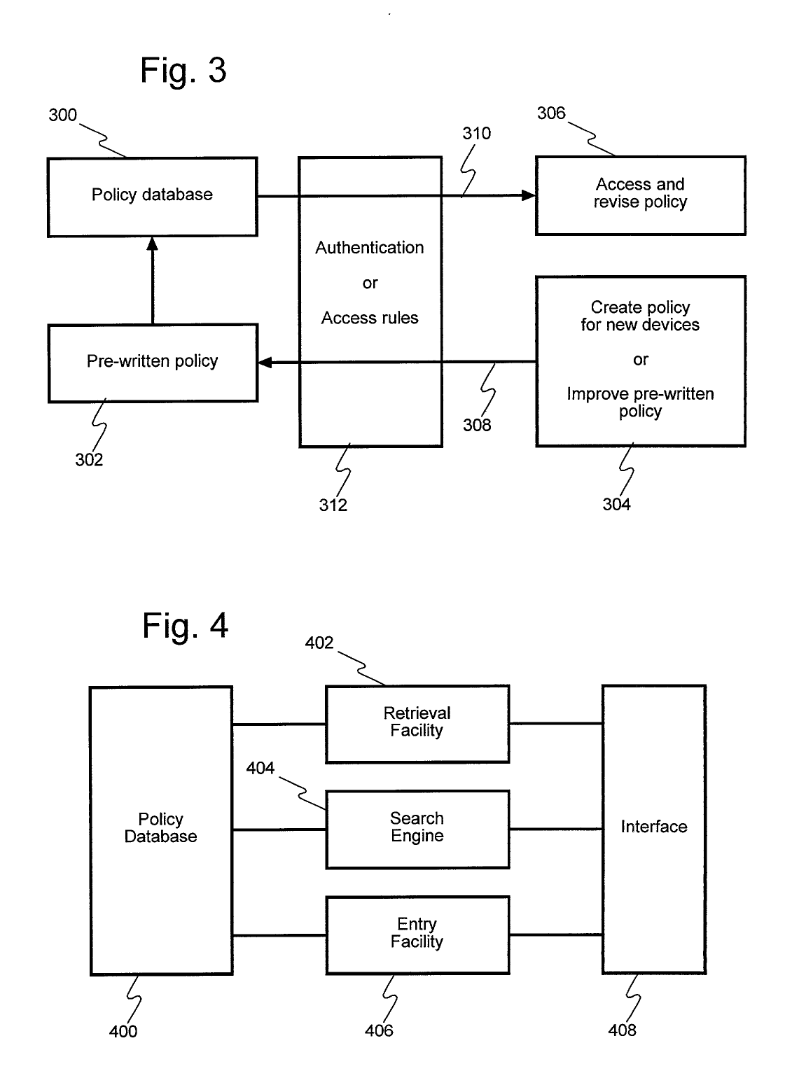

FIG. 3 illustrates by example a method of using a policy repository, whereby generic policy may be developed or tested, then made available to users who may apply the produced policy to their enterprise management applications. Policy is created that has been made generic for a particular enterprise device or set of devices, as shown by event 304. Alternately, existing generic policy may be revised, also shown in 304. This policy is published 308 to a collection of policies that remain untrusted or untested, 302. An authentication facility 312 may be used to prevent unauthorized entities from publishing policy. Such authentication is useful to prevent ignorant or malignant parties from improper policy submissions. The policy of the collection 302 is then reviewed or tested, and may be further revised as required. The reviewed policy is then delivered to the policy database 300, where it is made available for general use. Entities wishing to use policy in policy database 300 retrieve this policy 310 and revise it for a specific application 306. Authentication facility 312 may also be used to restrict access of delivery of the policy within policy database 300 to those having permission to do so. Such authentication is useful for providing a mechanism whereby subscription services may be maintained.

FIG. 4 illustrates by example a system of the invention. A database 400 contains generic policy. Each policy may be referenced, for example, by a policy identifier. A retrieval facility 402 permits retrieval of policy from database 400 by a policy identifier or other means. A search engine 404 may optionally be provided to locate policy applicable to a particular enterprise device. Search engine 404 accepts search criteria, such as device type or usage type, and delivers policy or policy references to the searcher. A facility for entering policy 406 to the database may be used in conjunction with the retrieval facility if entry to a common database is desired. Alternately, an updated database may be copied over database 400, in which case entry facility 406 is not necessary. An interface 408 is normally provided to permit ease of use of the retrieval, search, or entry facilities 402, 404, and 406.

While the present invention has been described and illustrated in conjunction with a number of specific embodiments, those skilled in the art will appreciate that variations and modifications may be made without departing from the principles of the inventions as herein illustrated, described and claimed.

The present invention may be embodied in other specific forms without departing from their spirit or characteristics. The described embodiments are to be considered in all respects as only illustrative, and not restrictive. The scope of the invention is, therefore, indicated by the appended claims, rather than the foregoing description. All changes that come within the meaning and range of equivalency of the claims are to be embraced within their scope.

1. A policy repository, comprising:
a database;
policy stored in said database, said policy providing generic conditions of evaluation, thresholds and actions, said policy being generally easy to modify for specific application of enterprise devices;
a retrieval facility for retrieving policy from said database;
and optionally an authentication facility whereby access through said retrieval facility may be restricted.

2. A policy repository system, comprising:
a database designed to contain generic policy;
a retreival facility whereby the generic policy may be retrieved from said database;
optionally an authentication facility whereby access through said retrieval facility may be restricted;
one or more transferential systems operating to receive policy from said database, said transferential systems being connected to an enterprise;
and a central information system in electronic communication with said transferential systems, said central information system enabled to provide enterprise device status to administrators.

3. A policy repository system, comprising:
a database designed to contain indexed generic policy;
a retrieval facility in communication with said database, said retrieval facility operating to retrieve generic policy contained in said database;
a search facility in communication with said database, said serach facility accepting search parameters, said search facility operating to locate policy of said database in conformance with the search parameters;
an entry facility in communication with said database, said entry facility accepting generic policy with index information, said entry facility also delivering the generic policy and the index information to said database;
an interface whereby an adminster may operate the retrieval, search, and entry facilities;
optionally an authentication facility whereby access through said retrieval, search, and entry facilities may be restricted;
and one or more enterprise management systems operating to receive policy from said database, said enterprise management systems being connected to an enterprise.

4. A method of producing generic policy for application to enterprises, the method comprising the steps of:
providing a policy database designed to contain generic policy;
accepting new generic policy, optionally through authentication;
optionally revising the new generic policy;
qualifying the new generic policy to produce accepted generic policy;
placing the accepted policy to the policy database;
and providing a retrieval facility whereby accepted generic policy may be retrieved from the database, optionally through authentication, the retrieved policy being easily modifyable and installable to an enterprise management system.

5. A method of providing generic policy for application to enterprses, the method comprising the steps of:
providing a policy database whereby generic policy has been entered, said database providing an index for said policy;
searching the policy database using a search criteria, said searching indicating corresponding policy of the database;
retrieving from the policy database at least a portion of the corresponding policy;
modifying the corresponding policy for a specific application of an enterprise device producing modified policy;
and installing the modified policy to an enterprise management system in communication with the enterprise device, such that the modified policy is utilized for the enterprise device.

6. A system for retrieving generic policy for enterprise management systems, comprising:
a database adapted to contain generic policy;
a retrieval facility in communication with said database, said retrieval facility operating to retrieve generic policy contained in said database.

7. The system of claim 6, further comprising:
a search facility in communication with said database, said search facility accepting search parameters, said search facility operating to locate policy of said database in conformance with the search parameters.

8. The system of claim 6, further comprising:
an entry facility in communication with said database, said entry facility accepting generic policy with index information, said entry facility also delivering the generic policy and the index information to said database.

9. A method of providing generic policy to administrators of enterprise management systems, comprising the steps of:
providing a policy database designed to contain generic policy;
providing means of retrieving policy from the database;
receiving at least one policy identifier;
and delivering policy contained in said database referenced with the policy identifier.

10. The method of claim 9, further comprising the steps of:
providing means of searching for policy in the database;
receiving policy search criteria;
searching the database using the search criteria;
identifying policy conforming to the search criteria.

11. The method of claim 10 wherein the search criteria includes a device type.

12. The method of claim 10 wherein the search criteria includes a usage type.

13. The method of claim 10 wherein the search criteria includes a use case.

14. The method of claim 9, further comprising the steps of:
providing an entry facility whereby generic policy may be added to the database;
receiving generic policy with index information;
storing the generic policy to the database with the index information.

15. A method of development and distribution of generic enterprise policy, comprising the steps of:
accepting submission of first policy;
development of first policy to produce second policy, said development including testing or modification of said first policy;
entering said second policy to a policy database;
providing access to the policy database whereby the second policy may be retrieved.

16. The method of claim 15 wherein the access to the policy database is restricted by authentication.

17. The method of claim 15 wherein said accepting submission of first policy is restricted by authentication.
